(19) United States
(12) Patent Application Publication
(10) Pub. No.: US 2025/0002100 A1
(43) Pub. Date: Jan. 2, 2025

(54) KICKSTAND FOR BICYCLES

(71) Applicant: IP CAPITAL FUND S.C.A., Luxembourg (LU)

(72) Inventor: Fabio LETTIERI, Luxembourg (LU)

(73) Assignee: IP CAPITAL FUND S.C.A., Luxembourg (LU)

(21) Appl. No.: 18/700,955

(22) PCT Filed: Sep. 15, 2022
(86) PCT No.: PCT/IB2022/058715

§ 371 Date: Apr. 12, 2024

(30) Foreign Application Priority Data
Oct. 13, 2021 (IT) 102021000026276

(51) Int. Cl. B62H 1/04; B62J 6/015; B62J 6/26; B62K 19/42

(52) U.S. Cl. CPC B62H 1/04; B62J 6/015; B62J 6/26; B62K 19/42

(57) ABSTRACT

A kickstand for bicycles including one base body associated with a frame of a bicycle; at least one leg associated with the base body and positionable in one lowered parking position and in one raised riding position; a signaling device/component/module/unit or the like that includes at least one signaling device associated with the leg configured to emit one light beam and oriented so as to project the light beam on the ground to define a light line alongside the bicycle when the leg is in the raised riding position; one electronic management and control unit operatively connected to the signaling device/component/module/unit and configured to detect whether the leg is in the raised riding position and to activate, as a result of the detection, the signaling device/component/module/unit.

### TECHNICAL FIELD

The present invention relates to a kickstand for bicycles.

### BACKGROUND ART

It is well known that nowadays more and more cyclists are involved in road accidents.

This fact is mainly attributable to an ever-increasing amount of motor vehicles on the road, which, especially in large cities, poses serious risks towards the safety of those riding bicycles.

In this regard, in fact, it should be noted that distraction of motor vehicle drivers is statistically the leading cause of traffic accidents.

The situation is even more dangerous in low visibility conditions, in which bicycles can be difficult to identify even to an attentive driver.

For example, such conditions are encountered at night, in foggy weather, and during particularly intense showers such that the visibility of motor vehicle drivers is greatly restricted.

No wonder, then, that there is an increasing need for cyclists to signal their presence.

In this regard, in fact, it is worth noting that cyclist signaling devices on the market, such as, e.g., headlights and reflectors, often prove insufficient in signaling the presence of the bicycle to one or more motor vehicles that are circulating in its proximity.

### DESCRIPTION OF THE INVENTION

The main aim of the present invention is to devise a kickstand for bicycles that can effectively signal the presence of a bicycle to those in its proximity, especially drivers of motor vehicles.

As part of this aim, the present invention aims to devise a kickstand for bicycles that can effectively signal the presence of a cyclist even in low-visibility situations such as, e.g., at night.

Another object of the present invention is to devise a kickstand for bicycles that can overcome the aforementioned drawbacks of the prior art within the framework of a simple, rational, easy-to-use and cost-effective solution.

The aforementioned objects are achieved by this kickstand for bicycles having the characteristics of claim 1.

### BRIEF DESCRIPTION OF THE DRAWINGS

Other characteristics and advantages of the present invention will become more apparent from the description of a preferred, but not exclusive, embodiment of a kickstand for bicycles, illustrated by way of an indicative, yet non-limiting example in the attached tables of drawings in which:

FIG. 1 is an axonometric overall view of a bicycle provided with the kickstand according to the invention;

FIG. 2 is a detailed view of the kickstand according to the invention with the legs positioned in the raised riding position;

FIG. 3 is a detailed view of the kickstand according to the invention with the legs positioned in the lowered parking position;

FIG. 4 shows in detail the base body of the kickstand according to the invention;

FIG. 5 is a schematic view of the electronic management and control unit.

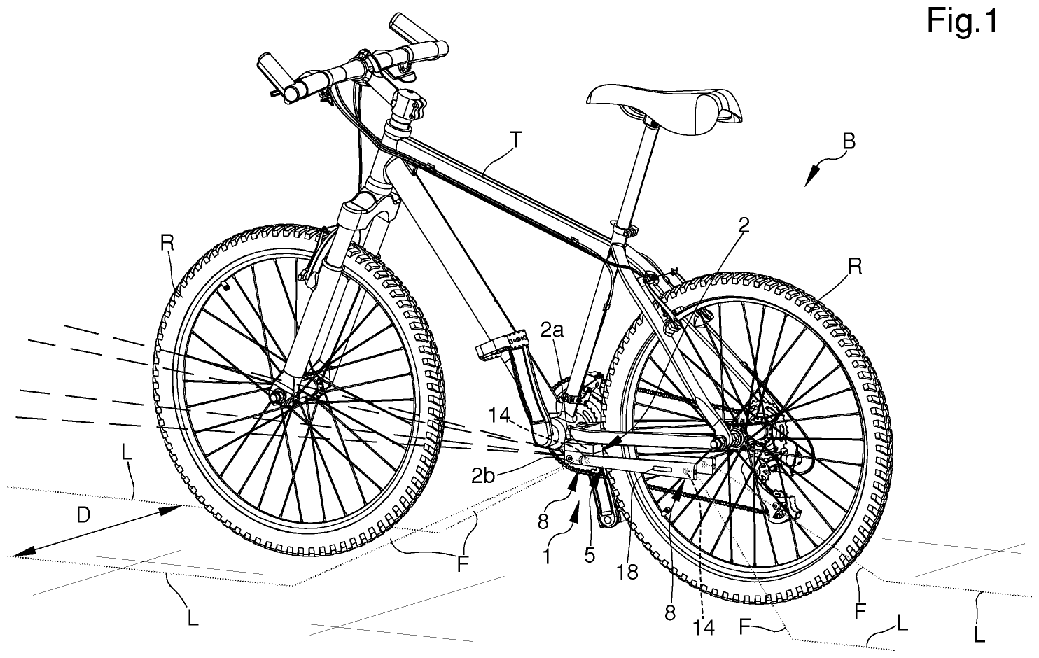

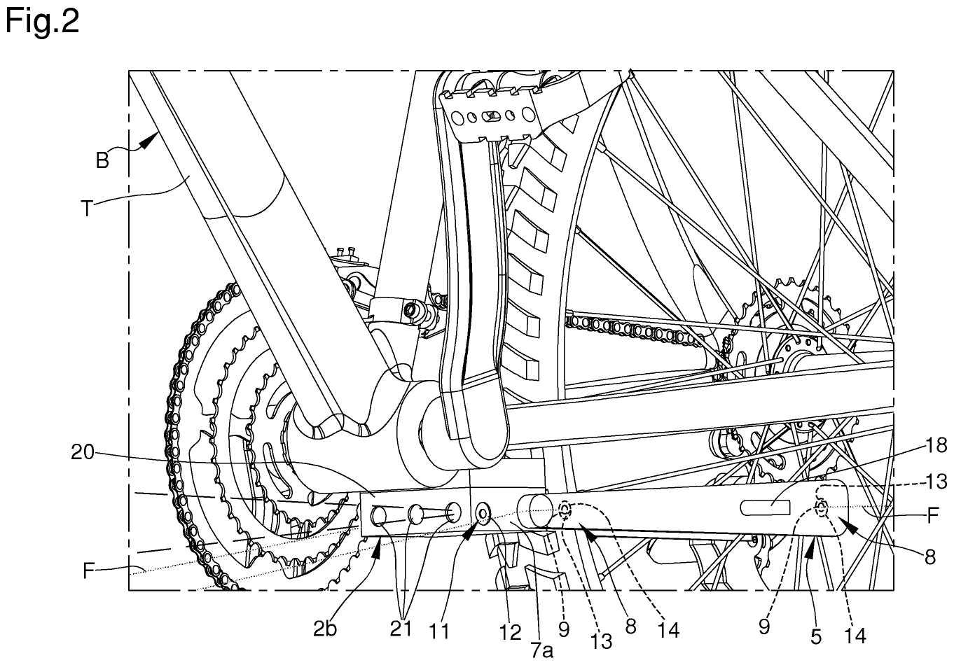

### EMBODIMENTS OF THE INVENTION

With particular reference to these figures, reference numeral 1 globally indicates a kickstand for bicycles.

The kickstand for bicycles 1 comprises at least one base body 2 associated with a frame T of a bicycle B.

Specifically, the base body 2 comprises at least a first base element 2a attachable to the frame T of a bicycle B.

In this regard, the first base element 2a is substantially shaped as a parallelepiped.

Again, the first base element 2a is made at least partly of plastic material.

For example, the first base element 2a is made at least partly of polypropylene (PP) and/or polyethylene (PE) and/or polyvinyl chloride (PVC) and/or other plastic materials still known to the expert in the field.

Conveniently, the first base element 2a is associated with fastening means 3 of the base body 2 to the frame T.

According to a preferred embodiment, the fastening means 3 are attached to the frame T at the junction point of the horizontal chainstays (so-called “low chainstays”) of the bicycle B.

In this case, the fastening means 3 comprise at least one threaded fastening element 4.

Preferably, the fastening element 4 is of the type of a bolt.

For example, the fastening element 4 comprises at least one plastic nut 4.

Fastening means 3 of different types cannot however be ruled out allowing the base body 2 to be attached to the frame T efficiently.

It is emphasized that the special expedient of providing fastening means 3 to the frame T allows the kickstand 1 to be installed on a bicycle B in an immediate, simple and intuitive manner.

It should also be emphasized that the special expedient of providing a fastening element 4 comprising at least one plastic nut 4 makes it possible to secure the base body 2 to the frame T in a particularly firm and strong manner, counteracting, for example, attempts to steal the kickstand 1 and its tampering and/or damage by malicious persons.

The kickstand 1 then comprises at least one leg 5, 6 which can rest on the ground to support the weight of the bicycle B.

Specifically, the leg 5, 6 is associated in a revolving manner with the base body 2 and is positionable in at least one lowered parking position and in at least one raised riding position.

In detail, the leg 5, 6 is pivoted to the base body 2.

Again, the leg 5, 6 is conformed in an elongated manner.

In other words, the leg 5, 6 has a similar conformation to the legs 5, 6 known to the technician in the field.

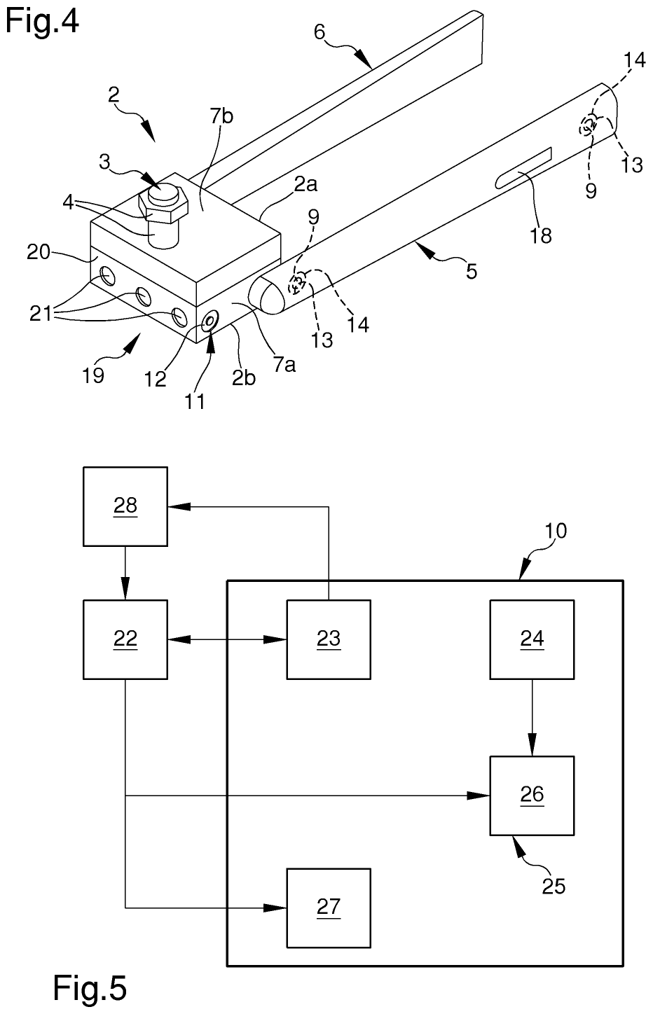

As visible in FIG. 4, the base body 2 comprises at least a second base element 2b associated with the first base element 2a in a removable manner.

In the present case, the second base element 2b is mechanically interlocked with the first base element 2a.

A differently conformed base body 2 cannot however be ruled out.

Specifically, a base body 2 made as a single body piece cannot be ruled out.

In other words, a base body 2 in which the first base element 2a and the second base element 2b are not distinct and separable bodies from each other but go together to define a monolithic base body 2 cannot be ruled out.

In particular, the leg 5, 6 is associated in a rotatable manner with the second base element 2b.

More specifically, the second base element 2b comprises at least two side surfaces 7a, the leg 5, 6 being associated with one of the two side surfaces 7a in a rotatable manner.

In other words, the leg 5, 6 is pivoted to one of the two side surfaces 7a.

The second base element 2b then comprises at least one upper surface 7b with which the first base element 2a is associated.

In this regard, the second base element 2b is substantially shaped as a parallelepiped.

In this case, the second base element 2b is shaped quite similarly to the first base element 2a.

Similarly to the first base element 2a, the second base element 2b is made at least partly of plastic material.

For example, the second base element 2b is made at least partly of polypropylene (PP) and/or polyethylene (PE) and/or polyvinyl chloride (PVC) and/or other plastic materials still known to the expert in the field.

According to the invention, the kickstand 1 comprises signaling means 8 adapted to signal the presence of the bicycle B comprising at least one signaling device 9 associated with the leg 5, 6 and configured to emit at least one light beam F.

Specifically, the at least one signaling device 9 is oriented so as to project the light beam F on the ground to define a light line L alongside the bicycle B when the leg 5, 6 is in the raised riding position.

In particular, the light beam F is of the type of a laser beam.

In other words, the signaling device 9 is of the type of a laser diode.

According to the preferred embodiment, the light beam F is of the type of a red laser beam.

The special expedient of providing a light beam F of the type of a laser beam, therefore, allows the presence of the bicycle B to be signaled even in low-visibility situations such as, e.g., at night.

According to the invention, the kickstand 1 comprises at least one electronic management and control unit 10 associated with the base body 2 and operatively connected to the signaling means 8.

In detail, the electronic management and control unit 10 is configured to detect whether the leg 5, 6 is in the raised riding position and to activate, as a result of the detection, the signaling means 8.

In particular, the electronic management and control unit 10 is associated with the second base element 2b.

Conveniently, the kickstand 1 comprises power supply means 11 of the signaling means 8 associated with the base body 2.

Specifically, the power supply means 11 are associated with the second base element 2b.

In particular, the power supply means 11 comprise at least one electrical energy storage device.

In the present case, the storage device is of the type of a rechargeable battery.

For example, the storage device is of the type of a rechargeable lithium battery.

In the present case, the storage device is arranged at least partly within the second base element 2b.

It cannot, however, be ruled out that the storage device is of the type of a rechargeable battery extractable from the second base element 2b.

This means that, in this case, the storage device can be conveniently loaded by means of an external electric charging device and/or by means of direct connection to the power grid.

Conveniently, the power supply means 11 comprise at least one connection port 12 for the electric charge of the storage device.

For example, the connection port 12 is of the type of a USB port.

In other words, the connection port 12 is conformed so that it is associable with a related cable provided with an end USB of the male type.

Different types of connection ports 12 to carry out the electric charge of the storage device cannot however be ruled out.

For example, the connection port 12 can be shaped so as to be associated with an “Italian-style” C7 power cable or with other types of cables still.

In this case, the connection port 12 is cut out on one of the two side surfaces 7a. Conveniently, the signaling means 8 comprise a plurality of signaling devices 9 associated with the leg 5, 6.

According to the preferred embodiment, the signaling means 8 comprise two signaling devices 9 associated with the leg 5, 6.

In the present case, one of the signaling devices 9 is oriented so as to emit the light beam F to define a first stretch of the light line L and the other of the signaling devices 9 is oriented so as to emit the light beam F to define a second stretch of the light line L substantially aligned with the first stretch.

In other words, the first stretch and the second stretch are substantially juxtaposed and collectively define the light line L.

A different number of signaling devices 9 associated with the leg 5, 6 cannot however be ruled out.

For example, the signaling means 8 comprising four signaling devices 9 associated with the leg 5, 6 cannot however be ruled out, each emitting the light beam F to define a first, a second, a third and a fourth stretch of the light line L, respectively.

Preferably, the leg 5, 6 is at least partly hollow to define inside it at least one housing 13 and is provided with at least one hole 14 obtained through and communicating with the housing 13.

Specifically, the signaling device 9 is housed at least partly inside the housing 13 and is arranged at the point where the hole 14 is located.

In detail, the signaling device 9 is arranged so as to emit the light beam F and have it pass through the hole 14.

Advantageously, the kickstand 1 comprises at least one first leg 5 and at least one second leg 6 mutually locked together in rotation around the base body 2.

Specifically, the first leg 5 and the second leg 6 are each pivoted on a respective side surface 7a.

In detail, the first and the second legs 5, 6 are arranged substantially parallel to at least one reference distance D.

To be precise, the reference distance D is greater than the width of the bicycle B.

This allows the light beam F to be projected onto the ground in a suitable and effective manner without the beam being deflected by hitting a wheel R of the bicycle, for example.

Specifically, at the reference distance D, the signaling devices 9 associated with the first leg 5 define a first light line L on one side of the bicycle B and the signaling devices 9 associated with the second leg 6 define a second light line L on the opposite side of the bicycle B.

In other words, the first light line L and the second light line L define a lane within which the bicycle B is placed.

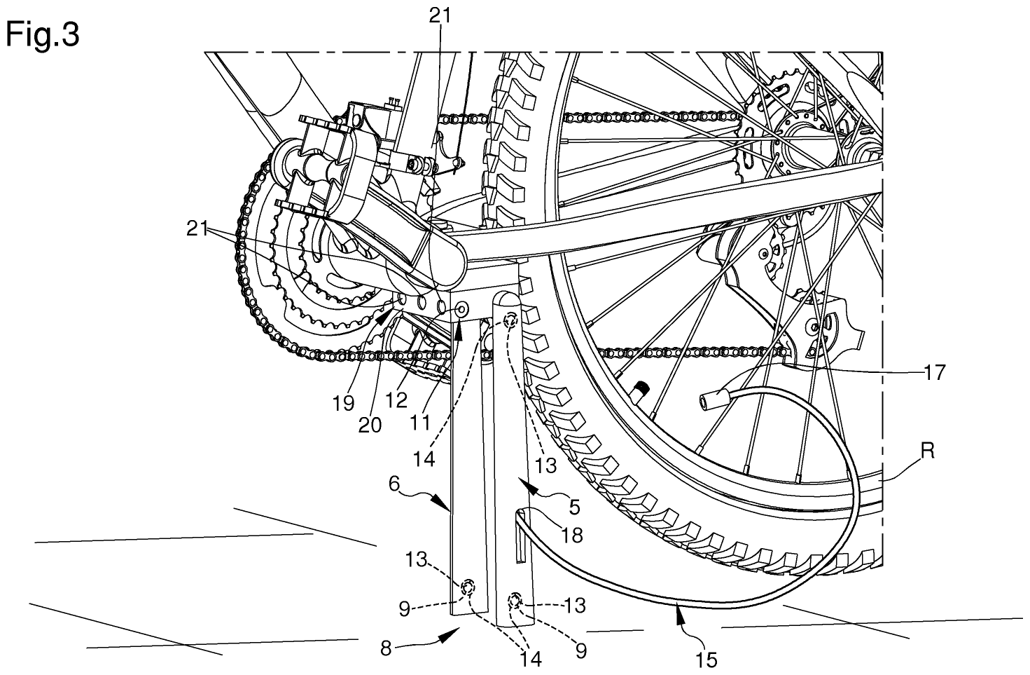

As visible in FIG. 3, the kickstand 1 comprises at least one inflation system 15 adapted to inflate at least one wheel R of the bicycle B, the inflation system 15 being associated with the leg 5, 6 and comprising at least one inflation body 15 fitted at least partly inside the housing 13.

In the preferred embodiment, the inflation system 15 is associated with the first leg 5 and with the second leg 6.

In this case, the inflation system 15 comprises a plurality of inflation bodies 15.

In particular, the inflation body 15 is shaped in a tubular manner.

In detail, the inflation body 15 is provided with at least one fixed end, not shown in the figures, attached to the housing 13.

Specifically, the inflation system 15 comprises two inflation bodies 15, one of the two inflation bodies 15 being fitted at least partly within a housing 13 and the other of the two inflation bodies 15 being fitted at least partly within the other housing 13.

In addition, the inflation body 15 is provided with at least one movable end 17 coupleable to a wheel R of the bicycle B for the inflation of the latter.

Specifically, the movable end 17 is coupleable to a valve of a wheel R of the bicycle B.

For example, the movable end 17 is coupleable to a valve of the Presta, Regina or Schrader type.

Optionally, the two inflation bodies 15 are provided with movable ends 17 different from each other and coupleable, in particular, with valves of different type.

For example, one of the two inflation bodies 15 may be provided with a movable end 17 coupleable with a valve of the Presta type and the other one of the two inflation bodies 15 may be provided with a movable end 17 coupleable with a valve of the Schrader type.

The possibility cannot however be ruled out of providing two inflation bodies 15 provided with movable ends 17 coupleable to valves of the same type or coupleable to other valves still than those listed above.

Conveniently, the inflation body 15 is at least partly extractable from the housing 13.

In this regard, the leg 5, 6 comprises at least one extraction slot 18 of the inflation body 15.

According to the preferred embodiment, the extraction slot 18 is positioned between the two holes 14.

In other words, it is possible to extract/replace the inflation body 15 from/to the housing 13 by pulling/pushing the inflation body itself and thus causing it to pass through the extraction slot 18.

It should be noted that the special expedient of providing a removable inflation body 15 allows the movable end 17 to be easily arranged where at least one wheel of the bicycle B is located, coupling it to the latter for the inflation thereof.

The inflation system 15 then comprises at least one air pressurization device, not shown in the figures, associated with the inflation body 15.

Preferably, the pressurization device is of the type of a pneumatic compressor, e.g. of the digital type.

In this case, the pressurization device is fitted, at least partly, within the second base element 2b.

Specifically, the pressurization device is configured to draw air from outside the base body 2 and to send it, after compressing it, to the inflation body 15.

Conveniently, the signaling means 8 comprise at least one front lighting device 19 associated with the base body 2 and configured to illuminate the bicycle B at the front.

In this regard, the second base element 2b comprises at least one front surface 20 positioned between the two side surfaces 7a, the front lighting device 19 being associated with the front surface 20.

In detail, the front lighting device 19 comprises a plurality of lights 21 of the LED type.

In the preferred embodiment, the front lighting device 19 comprises three lights 21 of the LED type.

Specifically, in the above embodiment, the lights 21 are of the white LED type.

A different number of lights 21 and/or lights 21 of different type such as, e.g., a central white LED positioned between two or more red laser beam emitters cannot however be ruled out.

The fact is emphasized that the special expedient of providing a front lighting device 19 allows for the presence of the bicycle to be signaled efficiently by illuminating in front of the latter.

Not only that, but the front lighting device 19 also allows the cyclist to ride more safely, thus reducing the likelihood of a traffic accident.

Advantageously, the electronic management and control unit 10 is operatively connected to at least one remote unit 22 accessible by at least one user configured to control the activation and deactivation of the signaling means 8 depending on at least one command given by the user.

Preferably, the remote unit 22 is of the type of a cell phone.

In particular, the electronic management and control unit 10 comprises at least one link module 23 to the remote unit 22.

For example, the link module 23 interacts with the remote unit 22 via Bluetooth BTLE protocol.

This enables quick and easy link between the electronic management and control unit 10 and the remote unit 22.

Communication protocols between the remote unit 22 and the electronic management and control unit 10 of different type such as, e.g., of the LoRa type or other types still known to the expert in the field cannot however be ruled out. In addition, the electronic management and control unit 10 comprises geo-location means 24 configured to detect geo-location coordinates of the kickstand 1.

Specifically, the geo-location coordinates are of the coordinates of the GPS type.

In this regard, the electronic management and control unit 10 comprises alarm means 25 operatively linked to the geo-location means 24 and operable by the remote unit 22 to detect any movement of the bicycle B and send at least one alarm signal to the remote unit 22.

For example, the alarm means 25 send at least one alarm signal to the remote unit 22 if the bicycle B runs a distance equal to or greater than a predetermined threshold limit.

Specifically, the alarm means 25 are associated with at least one sound signaling device 26 that can be activated upon detection of any movement of the bicycle B.

In this case, the sound signaling device 26 is of the type of a siren and/or loudspeakers.

In this regard, the electronic management and control unit 10 is configured to activate the signaling means 8 if the alarm means 25 detect any movement of the bicycle B.

Thus, the alarm means 25 allow for signaling that a possible theft of the bicycle B is in progress either through the activation of the signaling means 8 or through the activation of the sound signaling device 26.

In this regard, the electronic management and control unit 10 then comprises blocking means 27 for blocking at least one leg 5, 6 operable from the remote unit 22 and adapted to counteract the passage of the leg 5, 6 from the lowered parking position to the raised riding position.

So, the user can, conveniently, activate the blocking means 27 and avert, by doing so, any attempts to steal the bicycle B.

Conveniently, the electronic management and control unit 10 is operatively connected to at least one of the power supply means 11, the inflation system 15 and the alarm means 25.

In this regard, the inflation system 15 is operable by at least one command given by the user via the remote unit 22.

In addition, the electronic management and control unit 10 is configured to send at least one characteristic parameter to the remote unit 22 via the link module 23.

For example, the at least one characteristic parameter is selected from the list comprising: the percentage of electrical charge of the storage device, the value of inflation pressure of the wheels R, at least one alarm signal coming from the alarm means 25, at least one value of geo-location coordinates detected by the geo-location means 24.

In addition, the link module 23 is configured to communicate to at least one computerized control unit 28 via LTE CAT MI and/or GSM signal.

Specifically, the computerized control unit 28 is operatively connected to the remote unit 22 and is configured to send at least one characteristic parameter to the latter.

In this way, in fact, the computerized control unit 28 allows the user of the remote unit 22 to be informed about one or more of the characteristic parameters even when the distance between the remote unit 22 and the kickstand 1 is greater than the maximum coverage offered by the Bluetooth BTLE protocol.

It has in practice been ascertained that the described invention achieves the intended objects.

In particular, the fact is emphasized that the special expedient of providing suitable signaling means for signaling the presence of a bicycle allows for effective signaling of a cyclist's presence even in low-visibility situations such as, e.g., at night.

1. A kickstand for bicycles, the kickstand comprising:
at least one base body associated with a frame of a bicycle, wherein the bicycle having a weight;
at least one leg which is capable of resting on a surface or ground to support the weight of said bicycle, said leg being associated in a revolving manner with said base body and being positionable in at least one lowered parking position and in at least one raised riding position;
signaling means adapted to signal a presence of said bicycle and comprising at least one signaling device which is associated with said leg and is configured to emit at least one light beam, said at least one signaling device being oriented so as to project said light beam on the ground to define a light line-alongside said bicycle when said leg is in the raised riding position;
at least one electronic management and control unit associated with said base body, operatively connected to said signaling means and configured to detect whether said leg is in the raised riding position and to activate, as a result of said detection, said signaling means.

2. The kickstand according to claim 1, wherein said signaling means comprise a plurality of said signaling devices associated with said leg, one of said signaling devices being oriented so as to emit said light beam to define a first stretch of said light line and the other of said signaling devices being oriented so as to emit said light beam to define a second stretch of said light line substantially aligned with said first stretch.

3. The kickstand according to claim 1, wherein said light beam is of a type of a laser beam.

4. The kickstand according to claim 1, wherein said leg is at least partly hollow to define inside said leg at least one housing and is provided with at least one hole obtained through and communicating with said housing, said signaling device being accommodated at least partly inside said housing and being arranged at the point where said hole is located.

5. The kickstand according to claim 1, further comprising: at least one first leg and at least one second leg mutually locked together in rotation around said base body, said first and second legs being arranged substantially parallel to at least one reference distance at which said signaling devices associated with said first leg define a first light line on one side of said bicycle and said signaling devices associated with said second leg define a second light line on an opposite side of said bicycle.

6. The kickstand according to claim 1, further comprising: power supply means of said signaling means associated with said base body.

7. The kickstand according to claim 1, wherein said signaling means comprise at least one front lighting device associated with said base body and configured to illuminate said bicycle at a front of said bicycle.

8. The Kickstand according to claim 7, wherein said front lighting device comprises a plurality of lights of an LED type.

9. The kickstand according to claim 1, wherein said electronic management and control unit is operatively connected to at least one remote unit accessible by at least one user and configured to control the activation and deactivation of said signaling means depending on at least one command given by said user.

10. The kickstand according to claim 1, further comprising: at least one inflation system for inflating at least one wheel of said bicycle, said inflation system being associated with said leg and comprising at least one inflation body fitted at least partly inside said housing and provided with at least one movable end which can be coupled to said wheel for the inflation of said wheel.
